(19) United States
(12) Patent Application Publication
(10) Pub. No.: US 2009/0247089 A1
(43) Pub. Date: Oct. 1, 2009

(54) MULTICAST COMMUNICATION SYSTEM WITH POWER CONTROL

(75) Inventors: Wolfgang O. Budde, Aachen (DE); Salvador Expedito Boleko Ribas, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 11/721,695

(22) PCT Filed: Dec. 8, 2005
(86) PCT No.: PCT/IB2005/054116

§ 371 Date: Jun. 14, 2007

(30) Foreign Application Priority Data
Dec. 15, 2004 (EP) 04106594.7

(51) Int. Cl. H04B 7/005

(52) U.S. Cl. 455/69

(57) ABSTRACT

A method for delivering multicast communications over an IEEE 802.11 compliant network is provided. The method comprises transmitting a data stream to a plurality of receivers from a transmitter over respective network links as a multicast communication, selecting a receiver from the plurality of receivers; receiving a feedback signal from the selected receiver at a selected point in time; and adjusting transmission of the data stream in dependence upon the received feedback signal.

The present invention relates to multicast communications systems, and, in particular, to multicast communications using the IEEE 802.11 standard.

Although it is desirable to use an IEEE 802.11 compliant system for multicast communications, the IEEE 802.11 standard does not provide a MAC-level (Medium Access Control) recovery on broadcast or multicast frames (except for those frames sent with the ToDS (To Distribution System) bit set). As a result, the reliability of such traffic is reduced, relative to the reliability of directed traffic, due to the increased probability of lost frames from interference, collisions or time-varying channel properties. Any broadcast or multicast MPDU (MAC Protocol Data Unit) transferred from a STA (Station) with a ToDS bit set shall, in addition to conforming to the basic access procedure of CSMA/CA (Carrier-Sense Multiple Access/Collision Avoidance), obey the rules for RTS/CTS (Ready to Send/Clear to Send) exchange, because the MPDU is directed to the AP (Access Point).

Unicast is the term used to describe communication where a piece of information is sent from one point to another point. In this case there is just one sender, and one receiver.

Multicast is the term used to describe communication where a piece of information is sent from one or more points to a set of other points. In this case there is may be one or more senders, and the information is distributed to a set of receivers (there may be no receivers, or any other number of receivers).

Multicast clients receive a stream of packets only if they have previously elect to do so (by joining the specific multicast group address). Membership of a group is dynamic and controlled by the receivers (in turn informed by the local client applications).

The multicast mode is useful if a group of clients require a common set of data at the same time, or when the clients are able to receive and store (cache) common data until needed. Where there is a common need for the same data required by a group of clients, multicast transmission may provide significant bandwidth savings (up to 1/N of the bandwidth compared to N separate unicast clients).

As a consequence, the current lack of feedback information in IEEE 802.11 compliant systems on success (or failure) of packet transmission, or link condition from a receiving terminal's standpoint hampers the design of solutions permitting dynamic adaptation of transmission parameters (e.g. data rate, channel coding scheme, modulation and transmit power) to link condition changes detected through the transmission process.

Such handicaps become even more evident when multicast communication is used for audio or video streaming purposes, where large amounts of data are sent to the multicast destination group.

The IEEE 802.11 standard does, however, provide a reliable packet-wise MAC-level acknowledgement mechanism for the unicast communication case, which enables link adaptation and power control policies to be formulated.

Some simple, but still valuable, link adaptation solutions, such as that described in J. del Prado, S. Choi “Link Adaptation Strategy for IEEE 802.11 WLAN via Received Signal Strength Measurement” Proceedings of the IEEE International Conference on Communications (ICC'03), Anchorage, Ak., USA, Volume 2, pp. 1108-1113, 11-15 May 2003, rely on measurement of RSSI (Received Signal Strength Index) and perhaps background noise, from incoming feedback information, control or management frames such as ACK (acknowledgement frames) or periodical beacons. Such methods rely on the assumption that the uplink and downlink link condition between one terminal and the access point can be roughly estimated as being symmetric. Consequently, provided that acknowledgement messages were sent back to transmitting terminals, such algorithms might be applied, without farther modifications, to the multicast communication case.

Moreover, even some more advanced link-adaptation schemes, non-RSSI-based (such as those shown in D. Qiao, S. Choi, and K. G. Shin, “Goodput Analysis and Link Adaptation for IEEE 802.11a Wireless LANs, “IEEE Trans. On Mobile Computing (TMC), Volume 1, no. 4, pp. 278-292, October-December 2002 and A. Grilo, M. Nunes “Link Adaptation and Transmit Power Control for Unicast and Multicast in IEEE 802.11a/h/e WLANs” Proceedings of the 28^{th} Annual IEEE Conference on Local Computer Networks (LCN'03), Volume 1, pp. 334-345, 20-24 Oct. 2003) might be adopted as long as more and more high quality information on link condition and exchanged traffic features can be collected and then fed back to the transmitting side.

However, although enhanced performance might be attained by using the latter family of approaches, the former ones can be exploited by any sort of receiving terminals (including non-enhanced ones) as long as the AP (Access Point), through which all traffic (when operating in infrastructure mode) is relayed, is still an enhanced device.

According to one aspect of the present invention, there is provided a method for delivering multicast communications over an IEEE 802.11 compliant network, the method comprising the steps of:

(i) transmitting a data stream to a plurality of receivers from a transmitter over respective network links;

(ii) selecting a receiver from the plurality of receivers, and selecting a time point for generation of a feedback signal from the selected receiver;

(iii) receiving a feedback signal from the selected receiver at the selected time point; and

(iv) adjusting transmission of the data stream in dependence upon the received feedback signal,

wherein the data stream is transmitted to the plurality of receivers as a sequence of multicast messages.

According to another aspect of the present invention, there is provided an IEEE 802.11 compliant network comprising:

a transmitter (4) operable to transmit a multicast data stream to a plurality of receivers over respective network links;

a plurality of receivers (6a, 6b, 6c) each operable to receive a data stream from the transmitter; and

selection means operable to select one of the plurality of receivers and to select a time point for generation of a feedback signal,

wherein each receiver (6a, 6b, 6c) is operable to provide, at the time point, a feedback signal to the transmitter (4), in response to receipt of a selection signal issued by the selection means.

According to another aspect of the present invention, there is provided a transmitter for an IEEE 802.11 compliant network, the transmitter comprising:

a transmission unit operable to transmit a multicast data stream to a plurality of receivers over respective network links;

a selection unit operable to select one of a plurality of receivers and to select a time point for generation of a feedback signal,

wherein the transmitter is operable to issue a selection signal to a selected receiver, at the time point, and to receive a feedback signal from the selected receiver.

According to another aspect of the present invention, there is provided a receiver for use in an IEEE 802.11 compliant network, the receiver comprising:

a reception unit operable to receive a multicast data stream from a transmitter;

selection means operable to select a time point for generation of a feedback signal; and

a feedback unit operable to provide, at a selected time point, a feedback signal to a receiver of the network.

In one embodiment, each receiver includes a timer operable to select the time point. In that case. each receiver can reset its timer upon supply of a feedback signal by a receiver.

The feedback signal may contain parameters describing the reception quality at the receiver, or may contain suggested transmit parameters for the transmitter to send subsequent messages.

The selection unit of the transmitter can transmit a unicast selection message to the selected receiver, and may receive a feedback signal from a selected receiver in the form of a unicast message.

The feedback signal can be provided as a multicast message. Furthermore, the feedback signal may be supplied only if an equivalent feedback signal has not already been supplied.

For the multicast communication case having in mind
the number of receiving terminals which may form a multicast group, which is anticipated to be moderate for in-home scenarios
the contention-based medium access control scheme (CSMA/CA) used by the IEEE 802.11 standard
the real-time QoS-related constraints associated to audio and video streaming applications, which might involve no opening for packet re-transmission (ARQ)
   a packet-wise acknowledgement mechanism, resembling that devised for unicast communications, where each single packet delivery is to be acknowledged, from every member of the multicast group does not appear to be a pertinent approach to provide a feedback mechanism because of the associated overhead. Thus, according to the aforementioned issues such feedback solution should be selective. As a result, the resulting link-adaptation/power control scheme should probably result less accurate than its unicast communication counterpart, but still effective.

On the one hand selective feedback might consist in receiving terminals sending feedback information to the transmitting ones only on the occurrence of detection by the former of events such as obtrusive link condition degradation, of massive incoming packet-loss. Such feedback information on link quality variation, or transmission failure should be reported by receiving terminals to all its counterparts. But then, selective feedback might instead consist in receiving terminals being polled in order to report to the transmitting side about their link condition.

There are two options available for carrying, and making use of feedback information on link condition and transmission status:
1. At the data-link layer
2. At higher OSI stack layers (e.g. network, transport or even application layer)

The first option permits a faster response of the link adaptation mechanism, which can even work on a per data-link packet basis and therefore might be preferred for non-correlated traffic applications (e.g. file transfer). On the other hand, the second choice might favor the utilization of far more elaborated link adaptation schemes (than those ones relying on RSSI measurements). It yields a slower adaptation response, which can, however, still be effective for highly correlated traffic (e.g. streaming).

Closely related to the sort of exchanged traffic is the selection of a packet-wise acknowledgement policy versus a block-acknowledgement-based one. Again, the first policy is most appropriate to non-correlated traffic whereas the second one is more suited to correlated traffic.

Similarly, there are different alternatives concerning the terminal taking the lead to trigger the feedback mechanism. On the one hand, feedback can be requested by the transmitting terminal of the multicast communication, but on the other hand feedback can be issued upon decision of one of the receiving terminals.

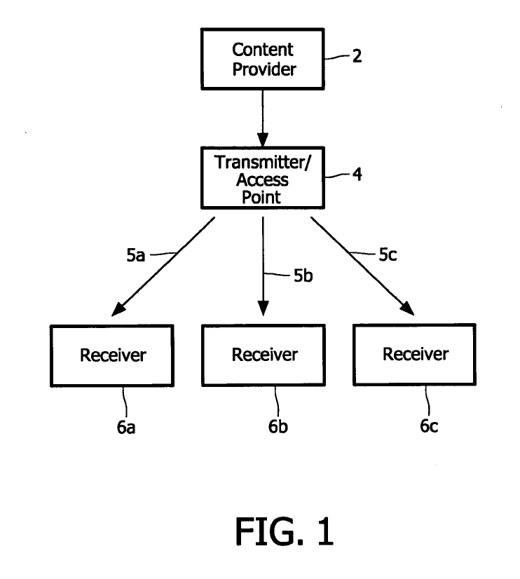

FIG. 1 illustrates a multicast communications system;

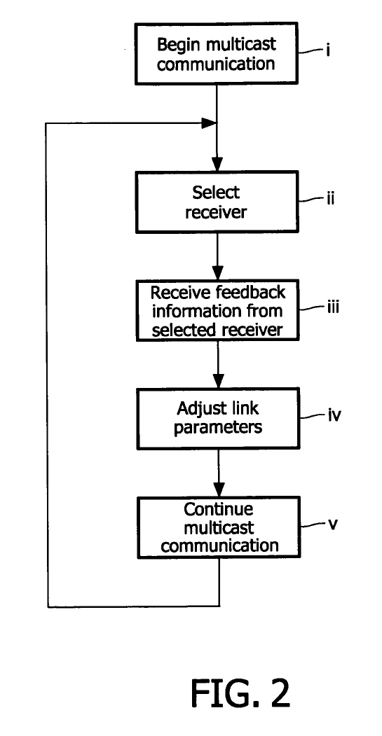

FIG. 2 illustrates a method embodying one aspect of the present invention;

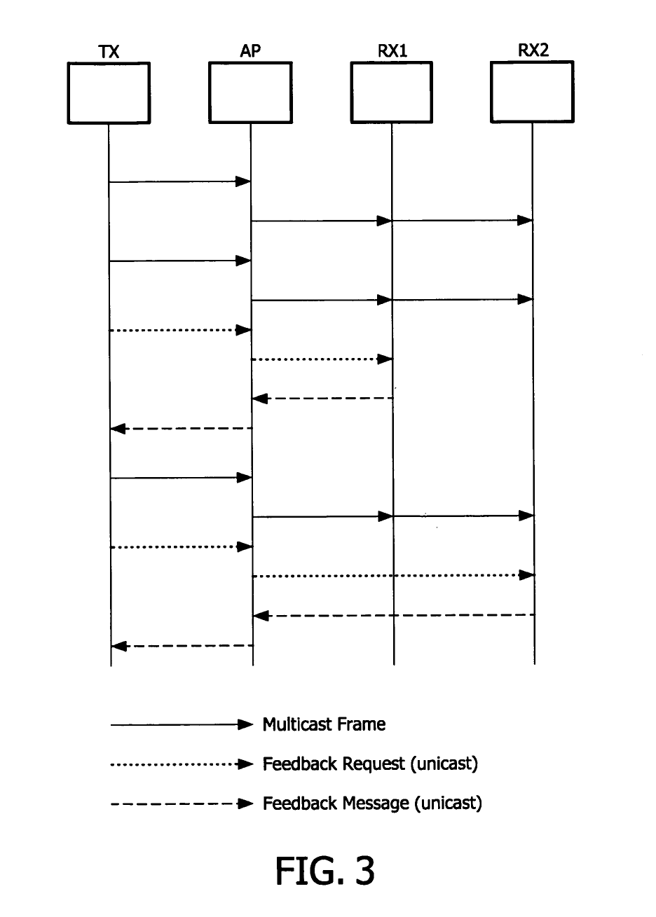

FIG. 3 illustrates timing in a first embodiment of the present invention; and

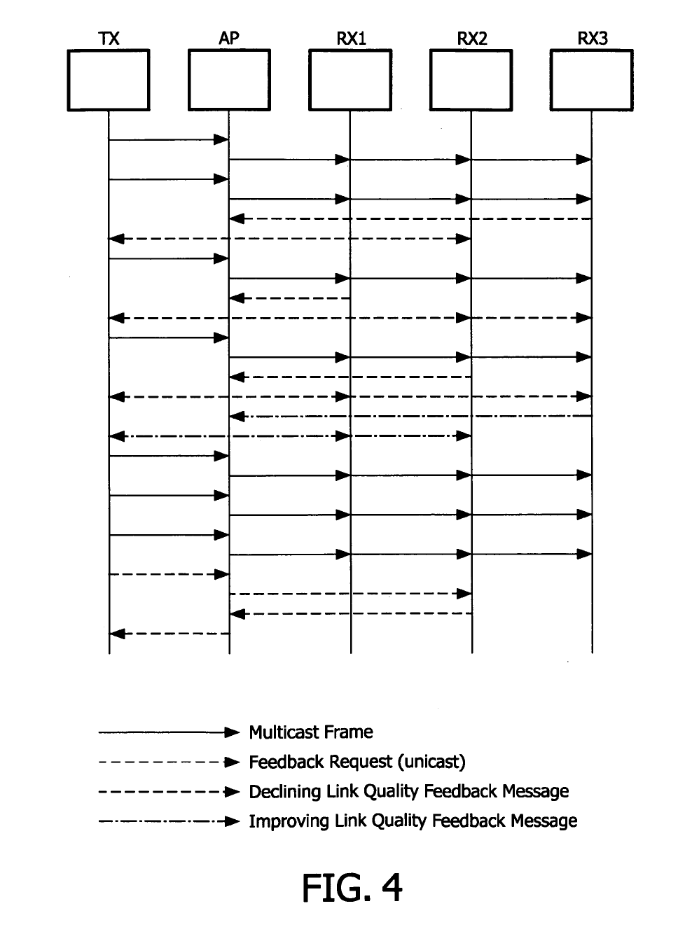

FIG. 4 illustrates timing in a second embodiment of the present invention.

FIG. 1 illustrates a network compliant with IEEE 802.11, and usable in accordance with the present invention. The network 1 includes a content provider 2, a transmitter 4 and a plurality of receivers 6a, 6b, 6c. It will be appreciated that any number of receivers 6 can be provided, and that only three are shown in FIG. 1 for the sake of clarity. The transmitter 4 is operable to perform multicast communications over network links 5a, 5b, 5c with the receivers 6a, 6b, 6c, by transmitting a data stream to the receivers. As stated above, an IEEE 802.11 compliant network is not directly suited to such multicast communications since suitable link performance feedback is lacking. Embodiments of the present invention set out to provide such link performance information to enable link adaptation. Operation of the network 1 will now be described with reference to the flow chart of FIG. 2.

FIG. 2 illustrates a method embodying one aspect of the present invention and FIG. 3 illustrates timing of signal transfers in the first embodiment

The transmitter 4 sends a multicast communication packet (or a certain amount of packets in a row, depending upon the nature of the exchanged traffic and whether a packet-wise or a block acknowledgement policy is in use), in step i—the multicast communication is commenced.

One of the receivers is then selected (step ii). This selection can be made by the transmitter 4, or by one or more of the receivers. In this preferred embodiment, the transmitter selects the receiver; more specifically the AP does it.

Then, the transmitter 4 sends, using a unicast communication mode, a selection signal such as a zero-length frame (i.e., a dummy message without data payload) to the selected one of the receivers 6a, 6b, 6c of the multicast groups.

In accordance with IEEE 802.11 standards, as a response to the received unicast message, the selected receiver sends back a feedback signal in the form of an acknowledgement message to the transmitter 4. Link performance information can then be extracted upon message reception through RSSI measurement. Such a scheme makes it possible to employ any one of many existing, unicast-mode-devised link adaptation schemes without need of any algorithmic modification.

In this preferred embodiment of the present invention, the feedback mechanism is driven by the transmitter. It is therefore possible for the transmitter 4 to determine whether the multicast data packets are expected to be acknowledged on a per packet or per block basis; to choose the size of the blocks when necessary depending on the number of receiving terminals associated with the receiving multicast group, and the delay constraints of the exchanged traffic, and for each requested acknowledgement select one of the receiving terminals by issuing the selection signal to it.

As a scheme to be used by the transmitter 4 to request feedback information from individual receivers, two alternatives are described in the context of this embodiment; further alternatives, employing any suitable algorithm to schedule the feedback request messages, are possible.

1. feedback is scheduled according to a round-robin sequence of receivers, that is according to a predetermined sequence, which may change as receivers join or leave the multicast group. In such cases the receiver list is updated on the occurrence of any event.
2. feedback is scheduled according to a uniformly-distributed random sequence of the receivers.

This preferred embodiment operates at the data-link layer and relies on a transmitter requested feedback policy. Acknowledgement can be packet-wise or block-wise depending on the exchanged traffic, the timeliness constraints of the traffic delivered by the on-going multicast transmission, and the selective feedback strategy consists of polling feedback information from only one receiver at a time according to a predetermined or random sequence.

There now follows a description of steps and issues regarding implementation of the first preferred embodiment of the invention, when feedback is scheduled according to a uniformly-distributed random sequence of receivers. Firstly, it is necessary to evaluate the value P, as the number of multicast packets that should be sent before a feedback message is scheduled.

Ideally, P should be chosen by considering the overhead that results from using feedback in the multicast communication scheme. This overhead should ideally not exceed too much, on average, that observed for the unicast case. In other word, the overhead due to the duration of the two expected phases of medium contention and feedback request, and corresponding feedback response time divided by the transmission and propagation time of P packets, should not exceed the ratio between the sum of the SIFS (Short Inter-Frame Space) duration plus an acknowledgement message transmission time. Accordingly, a preferred value for P is P>=3

More accurately, P>=1+(Tc+TDD)/(SIFS+TTACK), where Tc is the average medium contention time, TDD the time needed to transmit a dummy packet, SIFS is the short inter-frame space and TTACK the time needed to transmit an ACK message.

Moreover, further factors like the transmission mode in use or the sort of traffic being transmitted, e.g. its delay (timeliness) criticality, might be considered for the choice of the value of P. Indeed, the value of P might be adaptively computed by using the average value of the lastly N observed values of Tc in a fixed-size time window and assuming TTD<<Tc, and TTACK <<SIFS. Additionally, for the IEEE 802.11e case, access categories can be used to assign different priorities to different kinds of traffic or sources; similarly the value of P might be assigned different values in accordance with the access category value. The choice of feedback frequency-related value should balance the effectiveness of the link adaptation scheme with the effective data rate streamed to receiving terminals.

The selection of the receiver chosen to provide feedback can, as mentioned, be based on a random selection of available receivers. One exemplary method for creating this random choice is to evaluate a random variable u which follows a uniform probability density function at the interval [0, 1]. If the outcome u0, sampled from the random number generator, belongs to the interval [(r−1)/R, r/R) where R is the number of receivers in the multicast reception group, and r is a positive integer at the interval [1, R]. Then, the r^{th} receiver in the receiver list is chosen as the next one to be polled on its associated link condition.

The source terminal sends (1+ceil((R*u0−r+1)*(P−1))) out of P packets to the multicast reception group where the function ceil(x) is defined as follows. If x−a+b where b belongs to the open interval (0, 1) and a is a positive integer. If b<0.5, ceil(x)=a. Otherwise, ceil(x)=a+1.

Thus, the reception of at least one packet is guaranteed before the sender gets any feedback on link condition from any receiver

In a practical implementation of this embodiment of the present invention:
The transmitter 4 sends a feedback request, using unicast transmission mode, to the previously chosen receiver signaling a feedback request on its link condition. The feedback request is preferably a dummy data packet.
Using the IEEE 802.11 standard reliable scheme, the transmitter 4 is sent back an ACK (feedback) message by the selected receiver, from which message the link adaptation algorithm can be initiated
The transmitter 4 switches back to multicast transmission mode and sends the pending (P−1−ceil((R*u0−r+1)*(P−1))) out of P packets to the multicast reception group
The available receiver list can be updated according to the outcome of the link adaptation algorithm. If along a sliding time window, containing the last N values of transmission mode chosen by the link adaptation algorithm, it is observed that on average the resulting transmission mode is far less robust than the one in use before the poll, this fact might point that the link condition for that receiver is both stable and favorable, so that for some of the following rounds, polling the corresponding receiver might be skipped, i.e. temporarily disenrolled from the receiver list.

Such a procedure might be further refined removing from the receiver list, not just that receiver showing most favorable link condition on average for the last polling rounds, but also removing that one showing very severe link condition when compared to its receiving counterparts, since it might require a transmission mode ineffective to provide enough bandwidth according to the streaming application requirements and result in intolerable degradation of the quality of service for all the multicast group members.

Such temporary exclusion should hold as long as neither a certain time-out was reached nor any sharp downfall in link condition was observed for any receiver, since the latter might indicate the effect of a neighboring interference source affecting one or more receivers in the multicast group.

To summaries, optimal performance can be achieved if a transmitter embodying an aspect of the present invention, using a link-adaptation scheme based on RSSI measurements from incoming beacon frames (periodically sent by the transmitter) is used together with an enhanced Access Point which retrieves feedback signals from receivers according to the presented polling scheme, and integrates a link-adaptation scheme which can acquire information from RSSI measurements on received ACK messages.

It should be observed that in this embodiment only the access point must be enhanced to accommodate the advantages of the present invention. This is because, in the first embodiment, the receiving terminals simply reply to a dummy message with an acknowledgement message as they are obliged to according to IEEE 802.11 standards, and it is from it that all the required information for the link-adaptation algorithm is extracted.

A second preferred embodiment of the present invention will now be described with reference to the timing diagram of FIG. 4. In FIG. 4, several signal transfers are shown, and are labelled as follows:

a) indicates a multicast transmission frame,

b) indicates a unicast feedback request,

c) indicates a declining quality feedback signal, and

d) indicates an improving quality feedback signal.

In the second embodiment, selection of the receiver to provide feedback is performed by the receivers themselves. In this case, the selected receiver returns feedback information about link condition and transmission status over a time window, rather than instantaneous as in the previous embodiment.

The receivers make observations about the link quality and packet transmission status (e.g. lost packets detected due to packet numbering, corrupt packets, etc.).

When large magnitude degradation or melioration of link conditions is observed by any of the receivers, the receivers contend for the medium in order to report on such variation to the transmitting terminal. For that purpose, in order to meet the selective feedback requirements, some rules are applied.

1. Access to the medium should be prioritized for those receiving terminals detecting largest link condition variations. For instance, lengthier back-off periods for feedback on link condition might be assigned to smaller observed link condition variations.
2. A limited number Lr of receiving terminals should be allowed to send any feedback information after each transmission round.
3. Redundant feedback information should be avoided whenever possible (e.g. for some link adaptation solutions, there is no benefit in two terminals reporting similar link condition changes). Additionally, in order to detect terminals with similar link condition, a link quality measurement phase could be performed during start-up of the multicast session.

Consequently, any reporting feedback message should be transmitted to the source and rest of multicast group members by using multicast transmission mode, so that once Lr receivers have been reported, or the state of the medium has been captured by the source terminal, the transmission proceeds normally.

For the present case, due to the non-transmitter-unicast-requested nature of the feedback information, the underlying link-adaptation algorithm needs to be modified accordingly, with respect to its unicast communication mode implementation, and therefore would not allow co-existence with non-enhanced receiving transmitters and receivers.

However, such an approach allows as well link adaptation to be run at each of the receivers. Accordingly, the feedback information to be sent back to the source can just consist of recommended transmission parameter settings computed at the receivers.

Similar to the first embodiment, eventually one of the receivers in the receiver list may be polled to issue a feedback message. This message is to be understood as supplementary to the decision criteria above, since even without massive variations in link quality some feedback in carefully adjusted intervals should be sent. This protects against the case where massive link degradation inhibits the transmission of any further feedback message. Alternatively, receivers may decide locally, depending on their random number just drawn, whether to send a feedback message; the design of the random sequence should ensure that the chance of two such feedback messages contending on the medium is quite low.

The following implementation steps and issues are relevant when considering the second preferred embodiment.

The transmitter evaluates as the default timer interval size, T. This value is made known to every receiver in the multicast reception group. Such value might be chosen in accordance with the PHY mode.

The transmitter multicasts at least one packet to the multicast reception group. Immediately after its reception, the receivers schedule their stochastic timers in the interval [0, 1].

Independently, each receiver evaluates a random variable uk which follows a uniform probability distribution function at the interval [0, 1].

Then, a mathematical transform, X( ), is applied on the sampled value, uk, from the random number generator. Finally, the resulting quantity is multiplied by T+deltaT.

The additive term deltaT, is also independently computed by each receiver. It is a deterministic parameter weighing the precedence to report the sender on the link condition status of the receivers, i.e. it is used to count priority among receivers to feed their link condition status or transmission parameters proposal back to the sender. Some tentative precedence standards according to which, such value might be calculated have already been mentioned.

On the other hand, the mathematical transform X( ) is chosen to be the inverse of the cumulative density function chosen for the stochastic timer, since the expected value of feedback messages at the sender, and expected value of feedback latency due to the timer mechanism, are exponentially distributed.

$$X ( u ) = ( \frac{ln 1 + ( exp ( λ ) - 1 ) ⋆ u}{λ} )$$

appears to be a suited choice for the timers. As an alternative, a shifted power law M. Nevokee, W. H. Chong, S. Olafsson “An Optimized Timer-Based Method for Feedback Control in Multicast Communication” London Communications Symposium 2003.

X(u)=t|u−(b*t+(1−b)*t^{a})=0}

with shaping parameters a and b, can be employed as well. Where the transforms have been calculated using the well-known result of Statistics that if a random variable X has F(x) as cumulative density function, then the random variable u=F(x) is a uniformly distributed random variable at the interval [0, 1]. Thence, X can be generated by applying the inverse of the cumulative density function to a uniformly distributed random variable.

As soon as one of the timers expires, the associated receiver

1. either sends, in multicast mode to both the sender and the rest of members of the multicast reception group, the feedback message provided that no other feedback message has been previously by other receivers, in response to the last streaming episode.
2. or suppresses its feedback in case any other receiver has already provided any to the same source for the last round.

Hence, receivers should:

1. be able to differentiate the MAC address of the streaming source terminal(s), which might be acquired in a similar fashion to the value of T in use by the multicast reception group, whenever a terminal joins it.
2. set a flag every time a streaming episode gets started, and reset a flag whenever a feedback response is sent by the receiver or received from any other member of the multicast reception group. The flag status indicates whether the receiver is to send any feedback to the source, or not once the timer expires. Additionally, receivers should register not only individual source MAC addresses and values for T, but also separate feedback suppression flags for different streaming sources.

To summaries, the second preferred embodiment can be implemented at upper OSI stack layers, relies on a feedback-issued policy, again it can opt for a packet-wise or group acknowledgement depending on the nature of the exchanged traffic, and the selective feedback policy consists in bounded feedback, which is prioritized according to the relevance of the observed link condition degradation or melioration, and no redundancy (e.g. due to priorities, just the largest decline and improvement, if any, are reported after every transmission round).

For this second embodiment both the access point, which is transmitting, and the receiving terminals must be enhanced devices (that is, devices that are modified in accordance with the present invention). In the second embodiment the receiving terminals themselves determine and collect the link condition and transmission status information, and either

a) run link adaptation algorithms and feed the preferred transmission parameters settings back to the transmitter, or
b) merely feed the collected information back to the transmitter, which processes it.

1. A method for delivering multicast communications over an IEEE 802.11 compliant network, the method comprising the steps of:
(i) transmitting a data stream to a plurality of receivers from a transmitter over respective network links;
(ii) selecting a receiver from the plurality of receivers, and selecting a time point for generation of a feedback signal from the selected receiver;
(iii) receiving a feedback signal from the selected receiver at the selected time point; and
(iv) adjusting transmission of the data stream in dependence upon the received feedback signal,
wherein the data stream is transmitted to the plurality of receivers as a sequence of multicast messages.

2. A method as claimed in claim 1, wherein the step (ii) of selecting a receiver and selecting a time point is performed at the transmitter of the network, and includes sending a unicast selection message to the selected receiver from the, the feedback signal being returned to the transmitter from the selected receiver as a unicast message.

3. A method as claimed in claim 1, wherein the step (ii) of selecting a receiver and selecting a time point is performed at selected receiver, and the feedback signal is supplied as a multicast message to the transmitter and the other receivers.

4. A method as claimed in claim 3, wherein selection of the time point is performed using an independent timer in the selected receiver, and supply of the feedback signal is only performed if a feedback signal has not been received from one of the other receivers.

5. A method as claimed in claim 4, wherein, upon supply of a feedback signal by a receiver, the independent timers of the receivers are reset and restarted.

6. A method as claimed in claim 1, wherein the feedback signal sent by a receiver contains parameters describing the reception quality at the receiver.

7. A method as claimed in claim 1, wherein the feedback signal sent by a receiver contains suggested transmit parameters for the transmitter to send subsequent messages.

8. An IEEE 802.11 compliant network comprising:
a transmitter (4) operable to transmit a multicast data stream to a plurality of receivers over respective network links;
a plurality of receivers (6a, 6b, 6c) each operable to receive a data stream from the transmitter; and
selection means operable to select one of the plurality of receivers and to select a time point for generation of a feedback signal,
wherein each receiver (6a, 6b, 6c) is operable to provide, at the time point, a feedback signal to the transmitter (4), in response to receipt of a selection signal issued by the selection means.

9. A network as claimed in claim 8, wherein the selection means are provided by the transmitter (4), and are operable to transmit a unicast selection message to the selected receiver, the transmitter being operable to receive a feedback signal from a selected receiver as a unicast message.

10. A network as claimed in claim 8, wherein the selection means are provided by at least one of the receivers (6a, 6b, 6c), and the receivers are operable to transmit respective feedback signals as multicast messages to the transmitter and other receivers.

11. A network as claimed in claim 10, and wherein each receiver is operable to supply such a feedback signal only if an equivalent feedback signal has not been supplied by one of the other receivers.

12. A transmitter for an IEEE 802.11 compliant network, the transmitter comprising:
a transmission unit operable to transmit a multicast data stream to a plurality of receivers over respective network links;
a selection unit operable to select one of a plurality of receivers and to select a time point for generation of a feedback signal,
wherein the transmitter is operable to issue a selection signal to a selected receiver, at the time point, and to receive a feedback signal from the selected receiver.

13. A receiver for use in an IEEE 802.11 compliant network, the receiver comprising:
a reception unit operable to receive a multicast data stream from a transmitter;
selection means operable to select a time point for generation of a feedback signal; and
a feedback unit operable to provide, at a selected time point, a feedback signal indicative of network link performance.
